(19) United States
(12) Patent Application Publication
(10) Pub. No.: US 2009/0022986 A1
(43) Pub. Date: Jan. 22, 2009

(54) Adhesive security tape and method for its production

(75) Inventors: Ulrich Wesselmann, Gluecksburg (DE); Thomas Mangols, Erfurt (DE); Ulf Feistel, Laasdorf (DE)

Correspondence Address: DUANE MORRIS LLP - NY;PATENT DEPARTMENT, 1540 BROADWAY, NEW YORK, NY, 10036-4086, US

(73) Assignee: Jenoptik Automatisierungstechnik GmbH

(21) Appl. No.: 12/218,001

(22) Filed: Jul. 9, 2008

(30) Foreign Application Priority Data
Jul. 16, 2007 (DE) DE102007033702.9

(51) Int. Cl. B32B 7/06

(52) U.S. Cl. 428/345; 156/253

(57) ABSTRACT

The present invention relates to an adhesive security tape and to a method for its production. The adhesive security tape comprises first and second substrate layers that are connected to each other by means of a second adhesive layer and which can be attached by means of a first adhesive layer to an adhesive surface. The first substrate layer 2 has severing lines that completely penetrate at least part of the first substrate layer along the severing lines. The severing lines are preferably created with a laser beam, and the profile of the severing lines is designed so that the severing lines constitute an identifier.

### FIELD OF THE INVENTION

The present invention relates to an adhesive security tape as generically disclosed in Patent Application DE 10 2007 016 483 in the form of a cut-to-size adhesive security tab. A generic method, such as claimed in the present invention, is also disclosed in Patent Application DE 10 2007 016 483.

As used in the following description, an adhesive tab is defined as a ready-to-use piece of adhesive tape. It may be of fixed or random length.

### BACKGROUND OF THE INVENTION

Quite generally, an adhesive tab serves to connect at least two end pieces of a flat material, e.g., paper, cardboard or a sheeting material, in that the adhesive tab is attached so as to cover at least the end-to-end joint or the overlap joint between the end pieces.

Adhesive tabs which cannot be unnoticeably manipulated, i.e., which cannot be reversibly removed and reattached, will hereinafter be referred to as adhesive security tabs. They are especially suitable as anti-theft means for use on external packaging (hereinafter also referred to as packaging) in which a plurality of individual packages is unitized. Examples include, in particular, transport packaging for cartons of cigarettes, relatively small electronic devices and pharmaceutical products.

Adhesive tapes, from which such adhesive security tabs are obtained simply by cutting off tabs of a desired length, will be referred to as adhesive security tapes.

In order to create an effective tamperproof closure for packaging; in particular, made of paper or cardboard, the adhesive security tab must be attached to at least two packaging sections that lie end-to-end or overlap in such a manner that at least one of the packaging sections has to be detached in order to be able to open the packaging.

The prior art contains a large number of self-sealing adhesive tabs (hereinafter also referred to as adhesive tapes) or adhesive labels which are primarily used as labels for identification purposes which, because of their special layer structure, undergo visible irreversible alterations when tampered with, i.e., when an attempt is made to detach the labels from the packaging. Such specially designed adhesive tapes and adhesive labels are not readily commercially available and can therefore not be unnoticeably replaced.

JP-A 09-176990, for example, discloses an adhesive tape that comprises a pigment-containing layer with an adhesive constituent as well as a protective layer on top. As the adhesive tape is detached, the protective layer is completely removed, while part of the adhesive layer remains attached to the protective layer and part to the packaging; i.e., the pigment-containing layer is visibly damaged and any attempt to reattach it later on is clearly noticeable. The disadvantage is, in particular, that it is necessary to use special adhesives that must be incorporated into the pigment-containing layer.

DE 299 13 746 U1 discloses a layer structure for an adhesive label, comprising an intermediate layer of an adhesive layer, said intermediate layer having tear lines, and a full-length top sheet which is applied by means of an adhesive to the intermediate layer on which the tear lines are disposed. The top sheet serves to provide a smooth and readily printable surface so as to be able to create a printed image that is unimpaired by the tear lines on it.

The top sheet as the identification substrate should preferably be made of an easily destructible material in order to make it more difficult to detach the top sheet without destroying it.

The disadvantage of the adhesive label described in this document is that two different processing steps are necessary, a step for inserting the tear lines, e.g., by punching, and a step for printing the identifying information on the label.

DE 103 46 683 A1 discloses an adhesive label, comprising an adhesive layer and a sheeting structure with at least one layer which is weakened but not completely severed by means of a laser beam. A suitable sheeting material mentioned for this purpose is a polyester sheet which has a sufficiently high tear resistance and heat stability to keep the sheeting structure stable.

The material of which the sheeting layer next to the adhesive layer is made and the adhesive are selected to ensure that the adhesive label can be repositioned within a period of approximately half an hour. The degree to which the tear line is weakened, i.e., especially the depth of detachment, is selected to ensure that, depending on the material and the thickness, the adhesive label can be dispensed onto the object to which it is to be attached without risk of destroying the adhesive label, that the adhesive label can be repositioned with damaging it, and that after complete detachment of the adhesive layer, the adhesive label is uncontrollably torn when an attempt is made to remove the adhesive label.

In a preferred embodiment of the sheeting structure, a laser-sensitive layer is to be provided in addition to the sheeting layer that can be weakened by a laser beam. This offers the advantage that it is possible in a single step to insert a tear line into the weakenable sheeting layer and to print an identifier on the laser-sensitive layer.

As explained above, an adhesive label according to DE 103 46 683 A1 which is to serve both as identifier and as a security closure must comprise a special sheeting structure of at least two layers, or if only one layer is present, an identifier is possible only by means of the additional printing step.

The design feature all of the adhesive tabs and adhesive labels discussed above have in common is that they undergo irreversible alterations when an attempt is made to detach them so that once detached, the same adhesive tab or the same adhesive label cannot be used to reseal or reapply the tab or the label, respectively, and that, due to the special layer structure, an equivalent adhesive tab or an equivalent adhesive label is not readily available as a replacement.

DE 10 2007 016 483 discloses an adhesive security tab and a method for its production, said adhesive security tabs being produced by cutting a commercially available self-sealing adhesive packaging tape into desired lengths and subsequently being altered in a single step to ensure that they cannot be removed without destroying them and furthermore, that they constitute an identification substrate if so required. To this end, the adhesive security tab is attached as intended to an object (adhesive surface), which means that the adhesive security tab, as already described earlier, is attached so as to overlap at least two packaging end sections. After attachment, a laser beam is directed onto the surface of the adhesive security tab and passed along predefined severing lines so that the substrate material is removed along the severing lines. The severing lines can completely separate the adhesive security tab into its constituent pieces or they can partially separate only the substrate material. In both cases, an unnoticeable removal and reattachment of the adhesive security tab is rendered impossible. It is useful to design the line profile of the severing line in such a manner that this profile constitutes an identifier. This can be, e.g., a barcode or a character sequence.

The drawback of this solution is, in particular, that handling the laser tool required to carry out this step must be specifically matched to the object to which the tab is to be applied and to the adhesive site and that such a laser tool must be on hand when the package is to be sealed.

### SUMMARY OF THE INVENTION

The problem to be solved by the present invention is to make available an adhesive security tape and a method for its production, from which adhesive security tape it is possible to produce adhesive tabs that have severing lines which completely perforate at least part of the substrate material and can thus be cut from the adhesive security tape into prefabricated desired lengths.

This problem is solved with an adhesive security tape having the features of Claim 1 and with a method for the production of an adhesive security tape with the features of Claim 10.

Useful improvements are described in the dependent claims.

An adhesive security tape according to the present invention will be described in greater detail below using an example based on the drawing, in which:

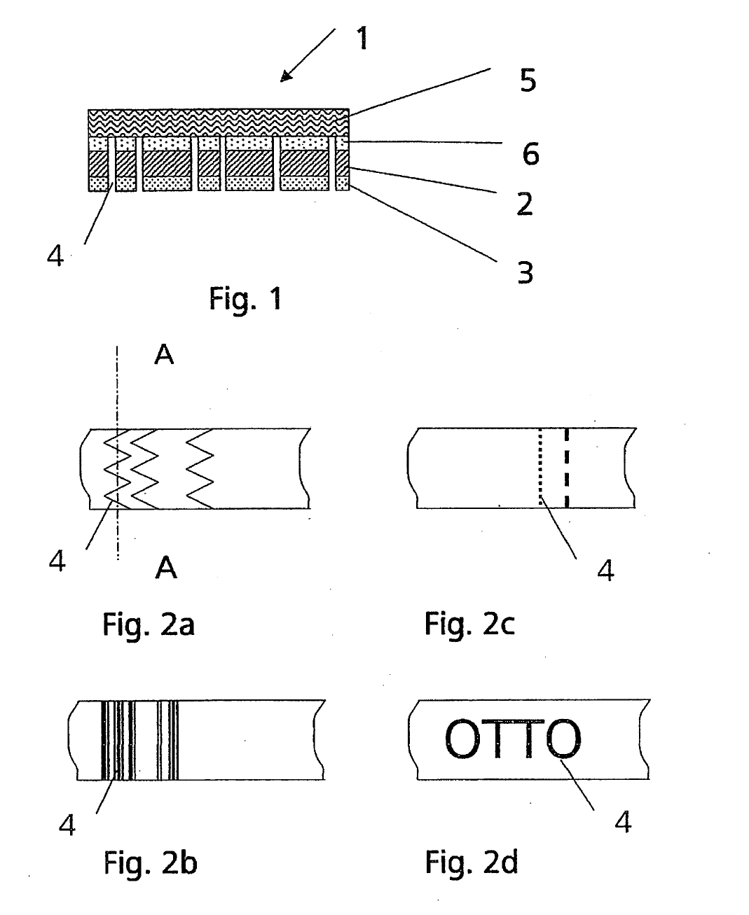

FIG. 1 shows a sectional view through an adhesive security tape; and

FIGS. 2a-2d show embodiments of adhesive tapes with different severing line profiles.

### DESCRIPTION OF EMBODIMENTS

In principle, an adhesive security tape 1 comprises a first substrate layer 2, a first adhesive layer 3, a second substrate layer 5 and a second adhesive layer 6, with at least part of the first adhesive layer 3 and part of the first substrate layer 2 being completely perforated along severing lines 4.

An especially useful embodiment of an adhesive security tape 1 produced by means of the method according to the present invention will be described below.

The choice of materials suitable for use as the adhesive layers 3, 6 and the substrate layers 2, 5 is primarily determined by the function of said layers.

The function of the first substrate layer 2 is to adhere permanently to an adhesive surface after a piece of an adhesive tab cut to a desired length from an adhesive security tape 1 has been applied to said surface. It should not be possible to remove this first substrate layer 2 without altering it from the adhesive surface or to reattach it in unaltered form. To this end, the first substrate layer 2 should have severing lines 4 which partially or completely separate the material of the first substrate layer 2.

When an attempt is made to detach the tape from the adhesive surface, severing lines which allow an only partial detachment of the tape, e.g., lines consisting of perforations or slits that are separated by joining strips, either cause the severing lines 4 to be torn open or the joining strips to be overstretched. In both cases, this leads to damage and noticeable alterations.

Although severing lines which allow a complete detachment of the tape, i.e., cuts that extend across the entire width of the adhesive security tape 1, make it possible to detach the tape without destroying it, the individual parts of the tape separated by the severing lines 4 cannot be reattached to precisely the same site, thereby also signaling that an alteration has been made.

The line profile can be specifically designed to create an identifier. Thus, the severing lines 4 are a feature that is not only relevant to security but that is relevant to identification as well

FIGS. 2a-2d show examples of special line profiles. Especially Examples 2a, 2c and 2d are suitable for machining with a laser. These examples show severing lines 4 having a constant width. In FIG. 2a, the severing lines are zigzag lines which completely sever the first substrate material across the entire width of the adhesive security tape 1.

FIG. 2c shows severing lines 4 consisting of a plurality of perforations and slits. The fewer the joining strips that connect the neighboring parts to one another, the greater will be the probability that these will be destroyed.

The example illustrated in FIG. 2d is interesting in that individual pieces remain attached to the adhesive security tape 1, which pieces, the smaller they are, cannot be removed without mechanically damaging them.

The example shown in FIG. 2b differs from the other examples in that the severing lines 4, which in this example constitute a barcode, have different widths. This is implemented by creating several severing lines 4 side by side without gaps in between.

The second substrate layer 5 serves as a support layer which ensures that the first substrate layer 2 remains securely attached while the severing lines 4 are inserted and that the parts of the first substrate layer 2 that are subdivided or severed by the severing lines 4 remain in the same unchanged position relative to one another. This second substrate layer continues to adhere to the first substrate layer 2 even after the severing lines 4 have been inserted and thus mechanically protects the first substrate layer 2 throughout handling, e.g., during transport and storage.

The adhesive security tape 1 is stored like prior-art adhesive tapes in the form of a continuous tape wound up on rolls.

To attach the tape, it can either be directly unwound from the roll and attached to the intended adhesive surface and subsequently be cut into desired lengths, or a piece of specified length is first cut off and then attached. As already explained earlier, a ready-to-use piece of the adhesive security tape 1 is here referred to as adhesive security tab.

As the tape is attached, the adhesive layer assumes the function of a new support layer for the first substrate layer 2, and the second substrate layer 5 loses its function.

If the severing lines 4 in the first substrate layer 2 also have an identifying function, the second substrate layer 5 must now be detached. What is important is that during this detachment, the first substrate layer 2 is not damaged.

With a view to the function, any flexible material that can be machined by means of a laser, i.e., any material that absorbs laser radiation is suitable for use as the first substrate layer 2. Preferably, these materials have a low tear resistance so that, independent of the weakening of the material along the predefined severing lines, it is difficult to detach these materials from an adhesive surface without destroying them.

It is useful if the material is irreversibly highly stretchable so that any attempt to remove the tape leads to overstretching and thus prevents an unnoticed reattachment.

Materials suitable for use as the first substrate layer 2 include PVC, PP or polyester as well as paper, preferably containing a natural rubber constituent.

For the second substrate layer 5, a highly tear-resistant flexible material should be used. This includes, e.g., woven fabrics, a synthetic material and paper.

Preferably, this material is not stretchable so as to prevent that the first substrate layer 2 is stretched and thus altered while the tape is being attached.

Preferably, this material does not absorb the radiation during laser machining or is coated with a layer that reflects the radiation during laser machining, thus ensuring that the second substrate layer 5 is not weakened by the radiation during laser machining.

Depending on the material and the roughness of the surface (adhesive surface) to which the tape is to be attached, the adhesive selected for use as the first adhesive layer 3 is an adhesive that adheres intimately to this adhesive surface so as to ensure high adhesion of the first substrate layer 2 indirectly via the first adhesive layer 3.

In contrast, the adhesive used for the second adhesive layer 6 makes it easy to detach the second substrate layer 5 and ensures that damage to the first substrate layer 2 is reliably avoided.

Accordingly, the adhesion between the two substrate layers 2, 5, indirectly mediated via the second adhesive layer 6, must be noticeably lower than the adhesion between the first substrate layer 2 and the adhesive layer indirectly mediated via the first adhesive layer 3.

The material to be used as adhesive layers is, e.g., acrylate.

The adhesive security tape 1 is preferably produced using a method according to the present invention. Instead of using a laser beam, the severing cuts can also be implemented by other removing or severing methods, such as mechanical needle-punching or cutting.

To carry out the method according to the present invention, first the multilayer material structure comprising the two substrate layers 2 and 5 and the two adhesive layers 4 and 6 is produced using conventional methods used to produce prior-art adhesive tapes, the multilayer structure is subsequently cut to the width defined for the adhesive security tape and wound onto rolls.

To insert the severing lines 4, the adhesive security tape, as it is in the process of being mechanically unwound from the roll, is passed through a laser machining section and subsequently wound onto a second roll. While the adhesive security tape 1 is pulled through the laser machining section, a laser beam is directed onto the adhesive layer 3 of the adhesive security tape 1. The necessary relative movement between the adhesive security tape I and the laser beam required to produce the severing lines 4 having a specific line profile is preferably a compound movement, determined by the direction and speed of the movement, on the one hand, and by the direction and speed of the movement of the laser beam, on the other hand.

The process parameters of a laser emitting the laser beam are set to ensure that a single passage of the laser along the severing lines 4 causes the first adhesive layer 3 and the first substrate layer 2 to be completely penetrated. It may be useful to use a continuously emitting a pulsed CO₂ laser.

It is obvious to the person skilled in the art that the severing lines 4 can also be produced by a plurality of lasers.

List of reference numerals
1 Adhesive security tape
2 First substrate layer
3 First adhesive layer
4 Severing lines
5 Second substrate layer
6 Second adhesive layer

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. An adhesive security tape comprising a flexible first substrate layer, a first adhesive layer applied to one of the two surfaces of the first substrate layer, at least part of the first substrate layer being completely penetrated along specified severing lines, a second flexible substrate layer adhered to the free surface of the first substrate layer via a second adhesive layer, said second substrate layer adapted to be removed after a desired length of an adhesive security tab has been cut off the adhesive security tape and the adhesive security tab has been attached as intended.

2. The adhesive security tape as in claim 1, wherein said severing lines are slits that extend across the width of the adhesive security tape.

3. The adhesive security tape as in claim 1, wherein said severing lines are lineups of slits that are separated by joining strips.

4. The adhesive security tape as in claim 1, wherein said severing lines are lineups of perforations.

5. The adhesive security tape as in claim 1 wherein said severing lines are formed as slits or perforations produced by removal of material by means of a machining laser beam and that the material of the first substrate layer absorbs the radiation of the machining laser.

6. The adhesive security tape as in claim 5, wherein the material of the first substrate layer contains a natural rubber constituent.

7. The adhesive security tape as in claim 5, wherein the material of the second substrate layer does not absorb the radiation emitted by the machining laser.

8. The adhesive security tape as in claim 5, wherein the second substrate layer facing the second adhesive layer is coated with a layer that reflects the radiation emitted by the machining laser.

9. The adhesive security tape as in claim 1 wherein said second substrate layer is made of a tear-resistant material to ensure that after attachment of a cut-to-size adhesive security tab, said material can be removed securely and in one piece from said adhesive security tab.

10. The adhesive security tape as in claim 1, wherein said line profile of the severing lines constitutes an identifier.

11. A method of producing an adhesive security tape, comprising applying a first adhesive layer onto a flexible first substrate layer which absorbs the radiation emitted by a machining laser, indirectly connecting a second flexible substrate layer via a second adhesive layer to the free surface of the first substrate layer, and directing the beam of a machining laser onto the first adhesive layer along predefined severing lines relative to the adhesive security tape so that the machining laser beam causes material to be completely severed along the severing lines at least in parts of the first substrate layer.
